(19) United States
(12) Patent Application Publication
(10) Pub. No.: US 2016/0177172 A1
(43) Pub. Date: Jun. 23, 2016

(54) USE OF ALKOXYLATED ALCOHOL ANIONIC SURFACTANT IN ENHANCED OIL RECOVERY

(71) Applicant: SHELL OIL COMPANY, Houston, TX (US)

(72) Inventors: Julian Richard BARNES, Amsterdam (NL); Cornelia Alida KROM, Amsterdam (NL); Quoc An ON, Amsterdam (NL); Sheila Teresa DUBEY, Sugar Land, TX (US); Khrystyna GROEN, Amsterdam (NL)

(21) Appl. No.: 15/058,651

(22) Filed: Mar. 2, 2016

(30) Foreign Application Priority Data
Oct. 19, 2015 (EP) 15190404.2

(51) Int. Cl. C09K 8/584

(52) U.S. Cl. CPC C09K 8/584

(57) ABSTRACT

The invention relates to a method of treating a hydrocarbon containing formation, comprising the following steps: a) providing a composition, which comprises a surfactant which is a compound of the formula (I) R—O—[R′—O]ₓ—X, wherein R is a hydrocarbyl group having a weight average carbon number of from 13 to 30, R′—O is an alkylene oxide group, x is the number of alkylene oxide groups R′—O, and X is selected from the group consisting of: (i) a group comprising a sulfate moiety; (ii) a group comprising a carboxylate moiety; and (iii) a group comprising a sulfonate moiety, to at least a portion of the hydrocarbon containing formation, wherein the hydrocarbon containing formation comprises a crude oil which has a weight ratio of saturates to aromatics of from 0.6 to 5.0; and b) allowing the surfactant from the composition to interact with the hydrocarbons in the hydrocarbon containing formation.

### FIELD OF THE INVENTION

The present invention relates to a method of treating a hydrocarbon containing formation using an alkoxylated alcohol anionic surfactant.

### BACKGROUND OF THE INVENTION

Hydrocarbons, such as oil, may be recovered from hydrocarbon containing formations (or reservoirs) by penetrating the formation with one or more wells, which may allow the hydrocarbons to flow to the surface. A hydrocarbon containing formation may have one or more natural components that may aid in mobilising hydrocarbons to the surface of the wells. For example, gas may be present in the formation at sufficient levels to exert pressure on the hydrocarbons to mobilise them to the surface of the production wells. These are examples of so-called “primary oil recovery”.

However, reservoir conditions (for example permeability, hydrocarbon concentration, porosity, temperature, pressure, composition of the rock, concentration of divalent cations (or hardness), etc.) can significantly impact the economic viability of hydrocarbon production from any particular hydrocarbon containing formation. Furthermore, the above-mentioned natural pressure-providing components may become depleted over time, often long before the majority of hydrocarbons have been extracted from the reservoir. Therefore, supplemental recovery processes may be required and used to continue the recovery of hydrocarbons, such as oil, from the hydrocarbon containing formation. Such supplemental oil recovery is often called “secondary oil recovery” or “tertiary oil recovery”. Examples of known supplemental processes include waterflooding, polymer flooding, gas flooding, alkali flooding, thermal processes, solution flooding, solvent flooding, or combinations thereof.

Methods of chemical Enhanced Oil Recovery (cEOR) are applied in order to maximise the yield of hydrocarbons from a subterranean reservoir. In surfactant cEOR, the mobilisation of residual oil is achieved through surfactants which generate a sufficiently low crude oil/water interfacial tension (IFT) to give a capillary number large enough to overcome capillary forces and allow the oil to flow (Lake, Larry W., “Enhanced oil recovery”, PRENTICE HALL, Upper Saddle River, N.J., 1989, ISBN 0-13-281601-6).

However, different reservoirs can have different characteristics (for example composition of the rock, crude oil type, temperature, water composition, salinity, concentration of divalent cations (or hardness), etc.), and therefore, it is desirable that the structures and properties of the added surfactant(s) be matched to the particular conditions of a reservoir to achieve the required low IFT. In addition, other important criteria may have to be fulfilled, such as low rock retention or adsorption, compatibility with polymer, thermal and hydrolytic stability and acceptable cost (including ease of commercial scale manufacture).

As mentioned above, different crude oil-bearing formations or reservoirs differ from each other in terms of crude oil type. Different crude oils comprise varying amounts of saturates, aromatics, resins and asphaltenes. Said 4 components are commonly abbreviated as “SARA”. Further, crude oils comprise varying amounts of acidic and basic components, including naphthenic acids and basic nitrogen compounds. Still further, crude oils comprise varying amounts of paraffin wax. These components are present in heavy (low API) crude oils and light (high API) crude oils. The overall distribution of such components in a particular crude oil is a direct result of geochemical processes.

The recovery of crude oil, containing components such as the above-mentioned saturates, aromatics, resins and asphaltenes and the above-mentioned acidic and basic components and paraffin wax, using surfactant cEOR is affected by the composition of the crude oil in question. For example, some of the said oil components may work as natural surfactants which would affect the performance of the (surfactant) chemicals added in surfactant cEOR. In addition, the pure hydrocarbon components (that is to say, containing no atoms other than carbon and hydrogen) from crude oils will interact with added surfactant(s) and affect sub-surface performance thereof. Therefore, the structure and properties of a surfactant, as used in surfactant cEOR need to be matched to the crude oil type in question to achieve a low IFT.

Such need for matching is also recognized in WO201330140A1. Said WO201330140A1 discloses the use of compositions comprising (i) an internal olefin sulfonate (IOS) and (ii) an anionic surfactant based on an alkoxylated alcohol (herein also referred to as “alkoxylated alcohol anionic surfactant” or “AAS surfactant”) as co-surfactant, in methods for cEOR. In particular, said WO201330140A1 is concerned with crude oils having a relatively low asphaltenes to resins ratio and a relatively high saturates to aromatics ratio.

In the present invention, it is desired to provide a method for cEOR for crude oils having a relatively high saturates to aromatics ratio, utilising an AAS surfactant. More in particular, it is desired to use an AAS surfactant which may have an improved cEOR performance in relation to such oils, for example in terms of reducing the IFT, as already described above. Further cEOR performance parameters other than said IFT, are optimal salinity and aqueous solubility at such optimal salinity. By “optimal salinity”, reference is made to the salinity of the brine present in a mixture comprising said brine (a salt-containing aqueous solution), the hydrocarbons (e.g. oil) and the surfactant(s), at which salinity said IFT is lowest. A good microemulsion phase behavior for the surfactant is desired since this is indicative for such low IFT and a low viscosity of the oil/water microemulsion. In addition, it is desired that at or close to such optimal salinity, said aqueous solubility of the surfactant is sufficient to good.

Thus, in the present invention, it is desired to improve one or more of the above-mentioned cEOR performance parameters for AAS surfactant compositions in relation to crude oils having a relatively high saturates to aromatics ratio.

### SUMMARY OF THE INVENTION

Surprisingly it was found that an alkoxylated alcohol anionic surfactant (“AAS surfactant”) containing composition which may have one or more of such improved cEOR performance parameters in relation to crude oils having a relatively high saturates to aromatics ratio, is a composition which comprises a surfactant which is a compound of the formula (I)

R—O—[R′—O]ₓ—X Formula (I)

wherein R is a hydrocarbyl group having a weight average carbon number of from 13 to 30, R′—O is an alkylene oxide group, x is the number of alkylene oxide groups R′—O, and X is selected from the group consisting of: (i) a group comprising a sulfate moiety; (ii) a group comprising a carboxylate moiety; and (iii) a group comprising a sulfonate moiety.

In particular, it was found that AAS surfactants having a weight average carbon number (for the nonalkoxylated alcohol precursor) of from 13 to 30, have a better cEOR performance in relation to crude oils having a relatively high saturates to aromatics ratio, as compared to AAS surfactants having a weight average carbon number lower than 13.

Accordingly, the present invention relates to a method of treating a hydrocarbon containing formation, comprising the following steps:

a) providing a composition, which comprises a surfactant which is a compound of the formula (I)

R—O—[R′—O]ₓ—X Formula (I)

wherein R is a hydrocarbyl group having a weight average carbon number of from 13 to 30, R′—O is an alkylene oxide group, x is the number of alkylene oxide groups R′—O, and X is selected from the group consisting of: (i) a group comprising a sulfate moiety; (ii) a group comprising a carboxylate moiety; and (iii) a group comprising a sulfonate moiety, to at least a portion of the hydrocarbon containing formation, wherein the hydrocarbon containing formation comprises a crude oil which has a weight ratio of saturates to aromatics of from 0.6 to 5.0; and

b) allowing the surfactant from the composition to interact with the hydrocarbons in the hydrocarbon containing formation.

### BRIEF DESCRIPTION OF THE DRAWINGS

FIG. 1A illustrates the reactions of an internal olefin with sulfur trioxide (sulfonating agent) during a sulfonation process.

FIG. 1B illustrates the subsequent neutralization and hydrolysis process to form an internal olefin sulfonate.

FIG. 2 relates to an embodiment for application in cEOR.

FIG. 3 relates to another embodiment for application in cEOR.

### DETAILED DESCRIPTION OF THE INVENTION

In the context of the present invention, in a case where a composition comprises two or more components, these components are to be selected in an overall amount not to exceed 100%.

While the method of the present invention and the composition used in said method are described in terms of “comprising”, “containing” or “including” one or more various described steps and components, respectively, they can also “consist essentially of” or “consist of” said one or more various described steps and components, respectively.”.

Within the present specification, “substantially no” means that no detectable amount is present.

In the cEOR method of the present invention, a composition is used which comprises a surfactant which is a compound of the formula (I)

R—O—[R′—O]ₓ—X Formula (I)

wherein R is a hydrocarbyl group having a weight average carbon number of from 13 to 30, R′—O is an alkylene oxide group, x is the number of alkylene oxide groups R′—O, and X is selected from the group consisting of: (i) a group comprising a sulfate moiety; (ii) a group comprising a carboxylate moiety; and (iii) a group comprising a sulfonate moiety.

In the present invention, the weight average carbon number for the hydrocarbyl group R in said formula (I) is of from 13 to 30, preferably 13 to 25, more preferably 14 to 25, more preferably 15 to 20, most preferably 15 to 18.

The hydrocarbyl group R in said formula (I) may be aliphatic or aromatic, suitably aliphatic. When said hydrocarbyl group R is aliphatic, it may be an alkyl group, cycloalkyl group or alkenyl group, suitably an alkyl group. Said hydrocarbyl group may be substituted by another hydrocarbyl group as described hereinbefore or by a substituent which contains one or more heteroatoms, such as a hydroxy group or an alkoxy group.

The non-alkoxylated alcohol R—OH, from which the hydrocarbyl group R in the above formula (I) originates, may be an alcohol containing 1 hydroxyl group (mono-alcohol) or an alcohol containing of from 2 to 6 hydroxyl groups (poly-alcohol). Suitable examples of poly-alcohols are diethylene glycol, dipropylene glycol, glycerol, pentaerythritol, trimethylolpropane, sorbitol and mannitol. Preferably, in the present invention, the hydrocarbyl group R in the above formula (I) originates from a non-alkoxylated alcohol R—OH which only contains 1 hydroxyl group (mono-alcohol). Further, said alcohol may be a primary or secondary alcohol, preferably a primary alcohol.

The non-alkoxylated alcohol R—OH, wherein R is an aliphatic group and from which the hydrocarbyl group R in the above formula (I) originates, may comprise a range of different molecules which may differ from one another in terms of carbon number for the aliphatic group R, the aliphatic group R being branched or unbranched, number of branches for the aliphatic group R, and molecular weight.

Preferably, the hydrocarbyl group R in the above formula (I) is an alkyl group. Said alkyl group may be linear or branched, and has a weight average carbon number of from 13 to 30, preferably 13 to 25, more preferably 14 to 25, more preferably 15 to 20, most preferably 15 to 18. In a case where said alkyl group is linear and contains 3 or more carbon atoms, the alkyl group is attached either via its terminal carbon atom or an internal carbon atom to the oxygen atom, preferably via its terminal carbon atom.

The non-alkoxylated alcohol R—OH, from which the hydrocarbyl group R in the above formula (I) originates, may be prepared in any way. For example, a primary aliphatic alcohol may be prepared by hydroformylation of a branched olefin. Preparations of branched olefins are described in U.S. Pat. No. 5,510,306, U.S. Pat. No. 5,648,584 and U.S. Pat. No. 5,648,585. Preparations of branched long chain aliphatic alcohols are described in U.S. Pat. No. 5,849,960, U.S. Pat. No. 6,150,222, U.S. Pat. No. 6,222,077.

Suitable examples of commercially available non-alkoxylated alcohols (of said formula R—OH) are the NEODOL (NEODOL, as used throughout this text, is a trademark) alcohols, sold by Shell Chemical Company. For example, said NEODOL alcohols include NEODOL 25 which is a mixture of mainly C₁₂, C₁₃, C₁₄ and C₁₅ alcohols of which the weight average carbon number is 13.5; NEODOL 45 which is a mixture of mainly C₁₄ and C₁₅ alcohols of which the weight average carbon number is 14.5; and NEODOL 67 which is a mixture of mainly C₁₆ and C₁₇ alcohols of which the weight average carbon number is 16.7.

The alkylene oxide groups R′—O in the above formula (I) may comprise any alkylene oxide groups. For example, said alkylene oxide groups may comprise ethylene oxide groups, propylene oxide groups and butylene oxide groups or a mixture thereof, such as a mixture of ethylene oxide and propylene oxide groups. Preferably, said alkylene oxide groups consist of ethylene oxide groups or propylene oxide groups or a mixture of ethylene oxide and propylene oxide groups. In case of a mixture of different alkylene oxide groups, the mixture may be random or blockwise. Most preferably, said alkylene oxide groups consist of propylene oxide groups.

In the above formula (I), x represents the number of alkylene oxide groups R′—O. In the present invention, the average value for x may be at least 0.5, suitably of from 1 to 50, more suitably of from 1 to 40, more suitably of from 2 to 35, more suitably of from 2 to 30, more suitably of from 2 to 25, more suitably of from 3 to 20, more suitably of from 3 to 18, more suitably of from 4 to 16, most suitably of from 5 to 12.

The above-mentioned (non-alkoxylated) alcohol R—OH, from which the hydrocarbyl group R in the above formula (I) originates, may be alkoxylated by reacting with alkylene oxide in the presence of an appropriate alkoxylation catalyst. The alkoxylation catalyst may be potassium hydroxide or sodium hydroxide which is commonly used commercially. Alternatively, a double metal cyanide catalyst may be used, as described in U.S. Pat. No. 6,977,236. Still further, a lanthanum-based or a rare earth metal-based alkoxylation catalyst may be used, as described in U.S. Pat. No. 5,059,719 and U.S. Pat. No. 5,057,627. The alkoxylation reaction temperature may range from 90° C. to 250° C., suitably 120 to 220° C., and super atmospheric pressures may be used if it is desired to maintain the alcohol substantially in the liquid state.

Preferably, the alkoxylation catalyst is a basic catalyst, such as a metal hydroxide, wick catalyst contains a Group IA or Group IIA metal ion. Suitably, when the metal ion is a Group IA metal ion, it is a lithium, sodium, potassium or cesium ion, more suitably a sodium or potassium ion, most suitably a potassium ion. Suitably, when the metal ion is a Group IIA metal ion, it is a magnesium, calcium or barium ion. Thus, suitable examples of the alkoxylation catalyst are lithium hydroxide, sodium hydroxide, potassium hydroxide, cesium hydroxide, magnesium hydroxide, calcium hydroxide and barium hydroxide, more suitably sodium hydroxide and potassium hydroxide, most suitably potassium hydroxide. Usually, the amount of such alkoxylation catalyst is of from 0.01 to 5 wt. %, more suitably 0.05 to 1 wt. %, most suitably 0.1 to 0.5 wt. %, based on the total weight of the catalyst, alcohol and alkylene oxide (i.e. the total weight of the final reaction mixture).

The alkoxylation procedure serves to introduce a desired average number of alkylene oxide units per mole of alcohol alkoxylate (that is alkoxylated alcohol), wherein different numbers of alkylene oxide units are distributed over the alcohol alkoxylate molecules. For example, treatment of an alcohol with 7 moles of alkylene oxide per mole of primary alcohol serves to effect the alkoxylation of each alcohol molecule with 7 alkylene oxide groups, although a substantial proportion of the alcohol will have become combined with more than 7 alkylene oxide groups and an approximately equal proportion will have become combined with less than 7. In a typical alkoxylation product mixture, there may also be a minor proportion of unreacted alcohol.

Further, in the present invention, X in the above formula (I) may be a group comprising a sulfate or carboxylate or sulfonate moiety, which are anionic moieties. That is to say, the compound of the above formula (I) is an anionic surfactant.

Further, in the present invention, the cation for the anionic surfactant of the above formula (I) may be any cation, such as an ammonium, alkali metal or alkaline earth metal cation, preferably an ammonium or alkali metal cation.

Surfactants of the formula (I) wherein X is a group comprising an anionic moiety may be prepared from the above-described alkoxylated alcohols of the formula R—O—[R′—O]ₓ—H, as is further described hereinbelow.

In a case where X in the above formula (I) is a group comprising a sulfate moiety, the surfactant is of the formula (II)

R—O—[R′—O]ₓ—SO₃⁻ Formula (II)

wherein R, R′ and x have the above-described meanings, and wherein the —O—SO₃⁻ moiety is the sulfate moiety. Preferably, in the present invention, X in the above formula (I) is a group comprising a sulfate moiety.

The alkoxylated alcohol R—O—[R′—O]ₓ—H may be sulfated by any one of a number of well-known methods, for example by using one of a number of sulfating agents including sulfur trioxide, complexes of sulfur trioxide with (Lewis) bases, such as the sulfur trioxide pyridine complex and the sulfur trioxide trimethylamine complex, chlorosulfonic acid and sulfamic acid. The sulfation may be carried out at a temperature preferably not above 80° C. The sulfation may be carried out at temperature as low as −20° C. For example, the sulfation may be carried out at a temperature from 20 to 70° C., preferably from 20 to 60° C., and more preferably from 20 to 50° C.

Said alkoxylated alcohol may be reacted with a gas mixture which in addition to at least one inert gas contains from 1 to 8 vol. %, relative to the gas mixture, of gaseous sulfur trioxide, preferably from 1.5 to 5 vol. %. Although other inert gases are also suitable, air or nitrogen are preferred.

The reaction of said alkoxylated alcohol with the sulfur trioxide containing inert gas may be carried out in falling film reactors. Such reactors utilize a liquid film trickling in a thin layer on a cooled wall which is brought into contact in a continuous current with the gas. Kettle cascades, for example, would be suitable as possible reactors. Other reactors include stirred tank reactors, which may be employed if the sulfation is carried out using sulfamic acid or a complex of sulfur trioxide and a (Lewis) base, such as the sulfur trioxide pyridine complex or the sulfur trioxide trimethylamine complex.

Following sulfation, the liquid reaction mixture may be neutralized using an aqueous alkali metal hydroxide, such as sodium hydroxide or potassium hydroxide, an aqueous alkaline earth metal hydroxide, such as magnesium hydroxide or calcium hydroxide, or bases such as ammonium hydroxide, substituted ammonium hydroxide, sodium carbonate or potassium hydrogen carbonate. The neutralization procedure may be carried out over a wide range of temperatures and pressures. For example, the neutralization procedure may be carried out at a temperature from 0° C. to 65° C. and a pressure in the range from 100 to 200 kPa abs.

In a case where X in the above formula (I) is a group comprising a carboxylate moiety, the surfactant is of the formula (III)

R—O—[R′—O]ₓ-L-C(═O)O⁻ Formula (III)

wherein R, R′ and x have the above-described meanings and L is an alkyl group, suitably a C₁-C₄ alkyl group, which may be unsubstituted or substituted, and wherein the —C(═O)O⁻ moiety is the carboxylate moiety.

The alkoxylated alcohol R—O—[R′—O]ₓ—H may be carboxylated by any one of a number of well-known methods. It may be reacted, preferably after deprotonation with a base, with a halogenated carboxylic acid, for example chloroacetic acid, or a halogenated carboxylate, for example sodium chloroacetate. Alternatively, the alcoholic end group may be oxidized to yield a carboxylic acid, in which case the number x (number of alkylene oxide groups) is reduced by 1. Any carboxylic acid product may then be neutralized with an alkali metal base to form a carboxylate surfactant.

In a specific example, an alkoxylated alcohol may be reacted with potassium t-butoxide and initially heated at for example 60° C. under reduced pressure for example 10 hours. It would be allowed to cool and then sodium chloroacetate would be added to the mixture. The reaction temperature would be increased to for example 90° C. under reduced pressure for for example 20-21 hours. It would be cooled to room temperature and water and hydrochloric acid would be added. This would be heated to for example 90° C. for for example 2 hours. The organic layer may be extracted by adding ethyl acetate and washing it with water.

In a case where X in the above formula (I) is a group comprising a sulfonate moiety, the second surfactant is of the formula (IV)

R—O—[R′—O]ₓ-L-S(═O)₂O⁻ Formula (IV)

wherein R, R′ and x have the above-described meanings and L is an alkyl group, suitably a C₁-C₄ alkyl group, which may be unsubstituted or substituted, and wherein the —S(═O)₂O⁻ moiety is the sulfonate moiety.

The alkoxylated alcohol R—O—[R′—O]ₓ—H may be sulfonated by any one of a number of well-known methods. It may be reacted, preferably after deprotonation with a base, with a halogenated sulfonic acid, for example chloroethyl sulfonic acid, or a halogenated sulfonate, for example sodium chloroethyl sulfonate. Any resulting sulfonic acid product may then be neutralized with an alkali metal base to form a sulfonate surfactant.

Particularly suitable sulfonate surfactants are glycerol sulfonates. Glycerol sulfonates may be prepared by reacting the alkoxylated alcohol R—O—[R′—O]ₓ—H with epichlorohydrin, preferably in the presence of a catalyst such as tin tetrachloride, for example at from 110 to 120° C. and for from 3 to 5 hours at a pressure of 14.7 to 15.7 psia (100 to 110 kPa) in toluene. Next, the reaction product is reacted with a base such as sodium hydroxide or potassium hydroxide, for example at from 85 to 95° C. for from 2 to 4 hours at a pressure of 14.7 to 15.7 psia (100 to 110 kPa). The reaction mixture is cooled and separated in two layers. The organic layer is separated and the product isolated. It may then be reacted with sodium bisulfite and sodium sulfite, for example at from 140 to 160° C. for from 3 to 5 hours at a pressure of 60 to 80 psia (400 to 550 kPa). The reaction is cooled and the product glycerol sulfonate is recovered. Such glycerol sulfonate has the formula R—O—[R′—O]ₓ—CH₂—CH(OH)—CH₂—S(═O)₂O⁻.

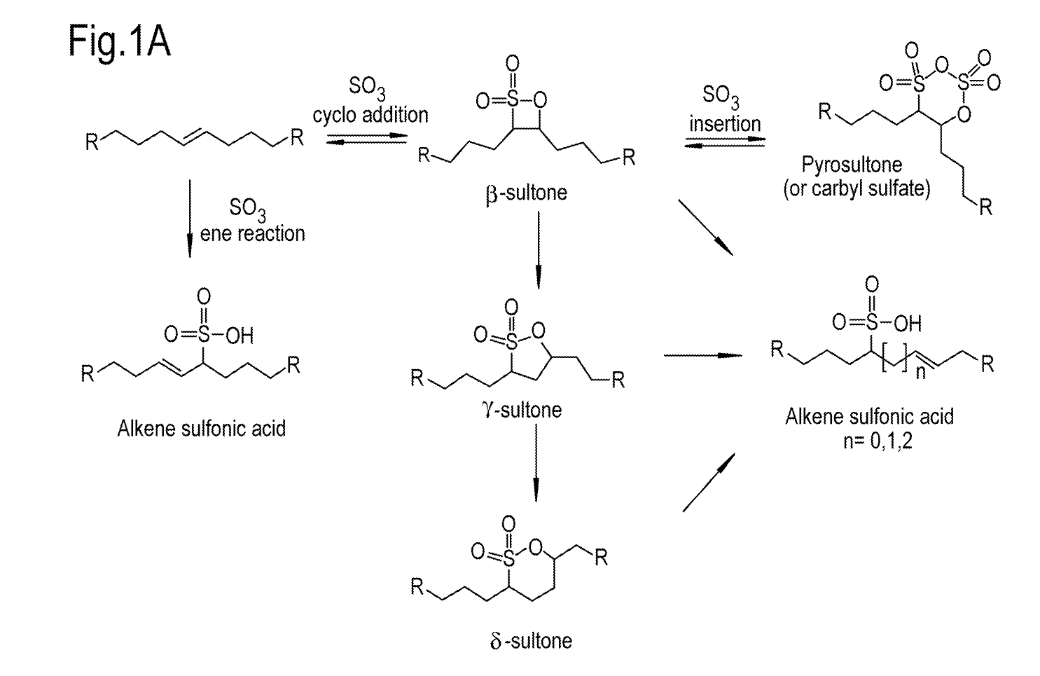

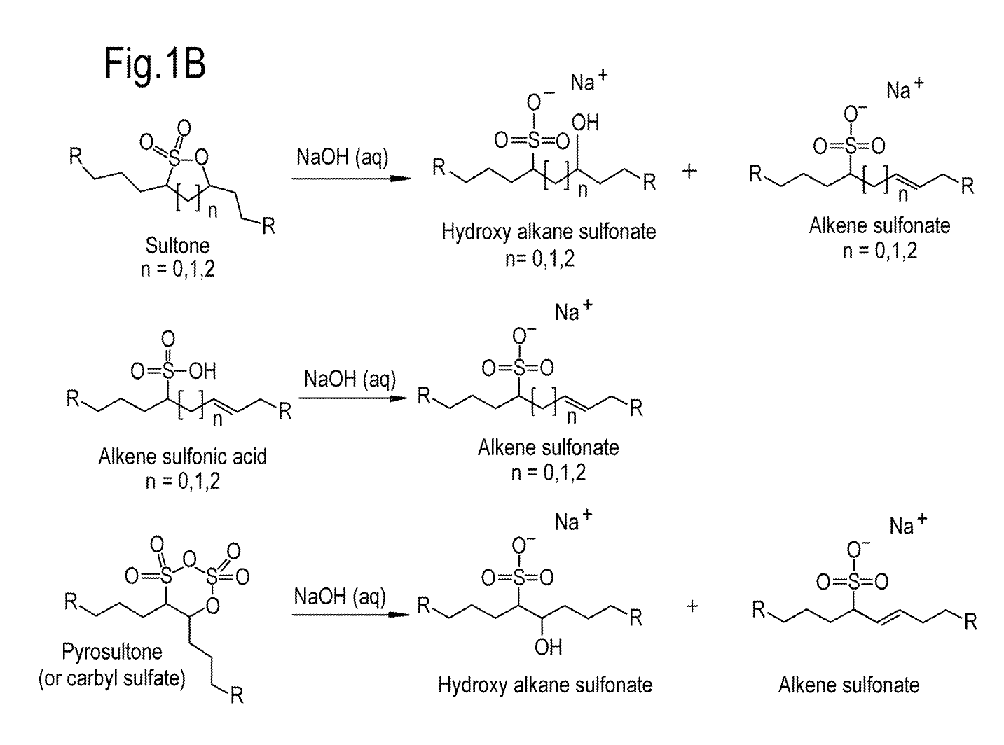

In addition to the above-described AAS surfactant, the composition used in the present cEOR method may also comprise an internal olefin sulfonate (IOS) as a second anionic surfactant. In a case where the composition comprises such IOS, the composition comprises internal olefin sulfonate molecules. An internal olefin sulfonate molecule is an alkene or hydroxyalkane substituted by one or more sulfonate groups. An internal olefin sulfonate molecule may be substituted by one or more hydroxy groups. Examples of such internal olefin sulfonate molecules are shown in FIG. 1B, which shows hydroxy alkane sulfonates (HAS) and alkene sulfonates (OS).

Thus, the composition used in the present cEOR method may comprise an internal olefin sulfonate. Said internal olefin sulfonate (IOS) is prepared from an internal olefin by sulfonation. Within the present specification, an internal olefin and an IOS comprise a mixture of internal olefin molecules and a mixture of IOS molecules, respectively. That is to say, within the present specification, “internal olefin” as such refers to a mixture of internal olefin molecules whereas “internal olefin molecule” refers to one of the components from such internal olefin. Analogously, within the present specification, “IOS” or “internal olefin sulfonate” as such refers to a mixture of IOS molecules whereas “IOS molecule” or “internal olefin sulfonate molecule” refers to one of the components from such IOS. Said molecules differ from each other for example in terms of carbon number and/or branching degree.

Branched IOS molecules are IOS molecules derived from internal olefin molecules which comprise one or more branches. Linear IOS molecules are IOS molecules derived from internal olefin molecules which are linear, that is to say which comprise no branches (unbranched internal olefin molecules). An internal olefin may be a mixture of linear internal olefin molecules and branched internal olefin molecules. Analogously, an IOS may be a mixture of linear IOS molecules and branched IOS molecules.

An internal olefin or IOS may be characterised by its carbon number, linearity, number of branches and/or molecular weight

In case reference is made to an average carbon number, this means that the internal olefin or IOS in question is a mixture of molecules which differ from each other in terms of carbon number. Within the present specification, said average carbon number is determined by multiplying the number of carbon atoms of each molecule by the weight fraction of that molecule and then adding the products, resulting in a weight average carbon number. The average carbon number may be determined by gas chromatography (GC) analysis of the internal olefin.

Within the present specification, linearity is determined by dividing the weight of linear molecules by the total weight of branched, linear and cyclic molecules. Substituents (like the sulfonate group and optional hydroxy group in the internal olefin sulfonates) on the carbon chain are not seen as branches. The linearity may be determined by gas chromatography (GC) analysis of the internal olefin.

Within the present specification, the average number of branches is determined by dividing the total number of branches by the total number of molecules, resulting in a “branching index” (BI). Said branching index may be determined by ¹H-NMR analysis.

When the branching index is determined by ¹H-NMR analysis, said total number of branches equals: [total number of branches on olefinic carbon atoms (olefinic branches)]+[total number of branches on aliphatic carbon atoms (aliphatic branches)]. Said total number of aliphatic branches equals the number of methine groups, which latter groups are of formula R₃CH wherein R is an alkyl group. Further, said total number of olefinic branches equals: [number of trisubstituted double bonds]+[number of vinylidene double bonds]+2*[number of tetrasubstituted double bonds]. Formulas for said trisubstituted double bond, vinylidene double bond and tetrasubstituted double bond are shown below. In all of the below formulas, R is an alkyl group.

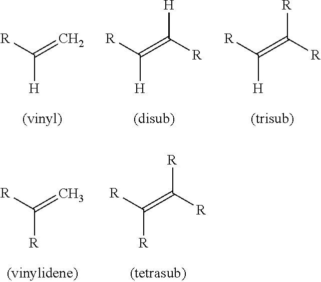

Within the present specification, said average molecular weight is determined by multiplying the molecular weight of each surfactant molecule by the weight fraction of that molecule and then adding the products, resulting in a weight average molecular weight.

The foregoing passages regarding (average) carbon number, linearity, branching index and molecular weight apply analogously to the first surfactant (the AAS surfactant) as described above.

Thus, the composition used in the present cEOR method may comprise an internal olefin sulfonate (IOS). Preferably at least 60 wt. %, more preferably at least 70 wt. %, more preferably at least 80 wt. %, most preferably at least 90 wt. % of said IOS is linear. For example, 60 to 100 wt. %, more suitably 70 to 99 wt. %, most suitably 80 to 99 wt. % of said IOS may be linear. Branches in said IOS may include methyl, ethyl and/or higher molecular weight branches including propyl branches.

Further, preferably, said IOS is not substituted by groups other than sulfonate groups and optionally hydroxy groups. Further, preferably, said IOS has an average carbon number in the range of from 5 to 30, more preferably 8 to 27, more preferably 10 to 24, more preferably 12 to 22, more preferably 13 to 20, more preferably 14 to 19, most preferably 15 to 18.

Still further, preferably, said IOS may have a carbon number distribution within broad ranges. For example, in the present invention, said IOS may be selected from the group consisting of C₁₅₋₁₈ IOS, C₁₉₋₂₃ IOS, C₂₀₋₂₄ IOS, C₂₄₋₂₈ IOS and mixtures thereof, wherein “IOS” stands for “internal olefin sulfonate”. IOS suitable for use in the present invention include those from the ENORDET™ O series of surfactants commercially available from Shell Chemicals Company.

“C₁₅₋₁₈ internal olefin sulfonate” (C₁₅₋₁₈ IOS) as used herein means a mixture of internal olefin sulfonate molecules wherein the mixture has an average carbon number of from 16 to 17 and at least 50% by weight, preferably at least 65% by weight, more preferably at least 75% by weight, most preferably at least 90% by weight, of the internal olefin sulfonate molecules in the mixture contain from 15 to 18 carbon atoms.

“C₁₉₋₂₃ internal olefin sulfonate” (C₁₉₋₂₃ IOS) as used herein means a mixture of internal olefin sulfonate molecules wherein the mixture has an average carbon number of from 21 to 23 and at least 50% by weight, preferably at least 60% by weight, of the internal olefin sulfonate molecules in the mixture contain from 19 to 23 carbon atoms.

“C₂₀₋₂₄ internal olefin sulfonate” (C₂₀₋₂₄ IOS) as used herein means a mixture of internal olefin sulfonate molecules wherein the mixture has an average carbon number of from 20 to 23 and at least 50% by weight, preferably at least 65% by weight, more preferably at least 75% by weight, most preferably at least 90% by weight, of the internal olefin sulfonate molecules in the mixture contain from 20 to 24 carbon atoms.

“C₂₄₋₂₈ internal olefin sulfonate” (C₂₄₋₂₈ IOS) as used herein means a mixture of internal olefin sulfonate molecules wherein the mixture has an average carbon number of from 24.5 to 27 and at least 40% by weight, preferably at least 45% by weight, of the internal olefin sulfonate molecules in the mixture contain from 24 to 28 carbon atoms.

Further, for the internal olefin sulfonates which are substituted by sulfonate groups, the cation may be any cation, such as an ammonium, alkali metal or alkaline earth metal cation, preferably an ammonium or alkali metal cation.

An IOS molecule is made from an internal olefin molecule whose double bond is located anywhere along the carbon chain except at a terminal carbon atom. Internal olefin molecules may be made by double bond isomerization of alpha olefin molecules whose double bond is located at a terminal position. Generally, such isomerization results in a mixture of internal olefin molecules whose double bonds are located at different internal positions. The distribution of the double bond positions is mostly thermodynamically determined. Further, that mixture may also comprise a minor amount of non-isomerized alpha olefins. Still further, because the starting alpha olefin may comprise a minor amount of paraffins (non-olefinic alkanes), the mixture resulting from alpha olefin isomeration may likewise comprise that minor amount of unreacted paraffins.

In the present invention, the amount of alpha olefins in the internal olefin may be up to 5%, for example 1 to 4 wt. % based on total composition. Further, in the present invention, the amount of paraffins in the internal olefin may be up to 2 wt. %, for example up to 1 wt. % based on total composition.

Suitable processes for making an internal olefin include those described in U.S. Pat. No. 5,510,306, U.S. Pat. No. 5,633,422, U.S. Pat. No. 5,648,584, U.S. Pat. No. 5,648,585, U.S. Pat. No. 5,849,960, EP0830315B1 and “Anionic Surfactants: Organic Chemistry”, Surfactant Science Series, volume 56, Chapter 7, Marcel Dekker, Inc., New York, 1996, ed. H. W. Stacke.

In the sulfonation step, the internal olefin is contacted with a sulfonating agent. Referring to FIG. 1A, reaction of the sulfonating agent with an internal olefin leads to the formation of cyclic intermediates known as beta-sultones, which can undergo isomerization to unsaturated sulfonic acids and the more stable gamma- and delta-sultones.

In a next step, sulfonated internal olefin from the sulfonation step is contacted with a base containing solution. Referring to FIG. 1B, in this step, beta-sultones are converted into beta-hydroxyalkane sulfonates, whereas gamma- and delta-sultones are converted into gamma-hydroxyalkane sulfonates and delta-hydroxyalkane sulfonates, respectively. Part of said hydroxyalkane sulfonates may be dehydrated into alkene sulfonates.

Thus, referring to FIGS. 1A and 1B, an IOS comprises a range of different molecules, which may differ from one another in terms of carbon number, being branched or unbranched, number of branches, molecular weight and number and distribution of functional groups such as sulfonate and hydroxyl groups. An IOS comprises both hydroxyalkane sulfonate molecules and alkene sulfonate molecules and possibly also di-sulfonate molecules. Hydroxyalkane sulfonate molecules and alkene sulfonate molecules are shown in FIG. 1B. Di-sulfonate molecules (not shown in FIG. 1B) originate from a further sulfonation of for example an alkene sulfonic acid as shown in FIG. 1A.

The IOS may comprise at least 30% hydroxyalkane sulfonate molecules, up to 70% alkene sulfonate molecules and up to 15% di-sulfonate molecules. Suitably, the IOS comprises from 40% to 95% hydroxyalkane sulfonate molecules, from 5% to 50% alkene sulfonate molecules and from 0% to 10% di-sulfonate molecules. Beneficially, the IOS comprises from 50% to 90% hydroxyalkane sulfonate molecules, from 10% to 40% alkene sulfonate molecules and from less than 1% to 5% di-sulfonate molecules. More beneficially, the IOS comprises from 70% to 90% hydroxyalkane sulfonate molecules, from 10% to 30% alkene sulfonate molecules and less than 1% di-sulfonate molecules. The composition of the IOS may be measured using a liquid chromatography/mass spectrometry (LC-MS) technique. U.S. Pat. No. 4,183,867, U.S. Pat. No. 4,248,793 and EP0351928A1 disclose processes which can be used to make internal olefin sulfonates. Further, the internal olefin sulfonates may be synthesized in a way as described by Van Os et al. in “Anionic Surfactants: Organic Chemistry”, Surfactant Science Series 56, ed. Stacke H. W., 1996, Chapter 7: Olefin sulfonates, pages 367-371.

In the present invention, a cosolvent (or solubilizer) may be added to (further) increase the solubility of the surfactant(s) in the composition used in the present cEOR method and/or in the below-mentioned injectable fluid comprising said composition. Suitable examples of cosolvents are polar cosolvents, including lower alcohols (for example sec-butanol and isopropyl alcohol) and polyethylene glycol. Any amount of cosolvent needed to dissolve all of the surfactant at a certain salt concentration (salinity) may be easily determined by a skilled person through routine tests.

Still further, the composition used in the present cEOR method may comprise a base (herein also referred to as “alkali”), preferably an aqueous soluble base, including alkali metal containing bases such as for example sodium carbonate and sodium hydroxide.

Thus, the present invention relates to a method of treating a hydrocarbon containing formation, comprising the following steps:

a) providing the above-described composition, which comprises the above-described AAS surfactant and optionally a second surfactant, such as an IOS surfactant, as also described above, to at least a portion of the hydrocarbon containing formation, wherein the hydrocarbon containing formation comprises a crude oil which has a weight ratio of saturates to aromatics of from 0.6 to 5.0; and

b) allowing the surfactant(s) from the composition to interact with the hydrocarbons in the hydrocarbon containing formation.

As mentioned above in the introduction, different crude oils comprise varying amounts of saturates, aromatics, resins and asphaltenes (the 4 so-called “SARA” components). Further, crude oils comprise varying amounts of acidic and basic components, including naphthenic acids and basic nitrogen compounds, and paraffin wax. These crude oil components can be easily measured using conventional oilfield chemistry methods, including industry ASTM and IP (Institute of Petroleum) methods.

Said SARA components can be measured by separation on the basis of their different solubility. First, the asphaltenes may be separated by precipitation using certain alkanes. The remaining soluble SARA components may then be separated by high performance liquid chromatography or column chromatography.

Within the present specification, the term “saturates” means compounds comprising hydrocarbons which contain substantially no carbon-carbon double bonds (C═C bonds) or carbon-carbon triple bonds (CC bonds). Though hydrocarbons are generally defined as molecules formed primarily of carbon and hydrogen atoms, they may also include other elements, such as halogens, metallic elements, nitrogen, oxygen and/or sulfur. For example, the saturates may comprise paraffins, such as normal-paraffins (linear alkanes), iso-paraffins (branched alkanes) and cyclo-paraffins (cyclic alkanes).

Preferably, the crude oil has a relatively high content of saturates. Preferably, the amount of saturates in the crude oil is of from 30 to 70 wt. %, more preferably 40 to 65 wt. %, based on total crude oil composition.

Within the present specification, the term “aromatics” means compounds which contain one or more aromatic rings. Aromatic rings may be conjugated rings of unsaturated carbon-carbon bonds. For example, aromatics may comprise benzene and its derivatives. Benzene derivatives may contain alkyl chains and cycloalkane rings.

Preferably, the crude oil has a relatively low content of aromatics. Preferably, the amount of aromatics in the crude oil is of from 20 to 50 wt. %, more preferably 30 to 45 wt. %, based on total crude oil composition.

Likewise, preferably, the weight ratio of saturates to aromatics in the crude oil is relatively high. That is to say, said weight ratio is of from 0.6 to 5.0, preferably 0.6 to 3.0, more preferably 0.7 to 2.5, even more preferably 0.8 to 2.0.

Within the present specification, the term “resins” means compounds which are soluble in higher molecular weight normal alkanes, such as n-heptane, and insoluble in lower molecular weight normal alkanes, such as propane.

Preferably, the crude oil has a relatively low content of resins. Preferably, the amount of resins in the crude oil is of from 3 to 12 wt. %, more preferably 4 to 11 wt. %, based on total crude oil composition.

Within the present specification, the term “asphaltenes” means compounds which are a) insoluble in light alkanes such as n-pentane or n-hexane and b) soluble in aromatic solvents such as toluene and benzene. Asphaltenes are not a specific family of chemicals with common functionality and varying molecular weight. They are a continuum of material—generally at the high end in molecular weight, polarity and aromaticity—some of which may separate as an additional solid phase in response to changes in pressure, composition, and/or temperature. Asphaltenes may comprise polycyclic aromatic clusters substituted with varying alkyl side chains with metal species and the molecular weight may be in the 500-2000 g/mole range.

Preferably, the crude oil has a relatively low content of asphaltenes. Preferably, the amount of asphaltenes in the crude oil is of from 0.01 to 6 wt. %, more preferably 0.05 to 3 wt. %, most preferably 0.1 to 2 wt. %, based on total crude oil composition. Preferably, the maximum for the amount of asphaltenes in the crude oil is 6 wt. %, more preferably 4 wt. %, more preferably 3 wt. %, more preferably 2 wt. %, more preferably 1 wt. %, more preferably 0.5 wt. %, most preferably 0.3 wt. %. Preferably, the minimum for the amount of asphaltenes in the crude oil is 0.001 wt. %, more preferably 0.01 wt. %, more preferably 0.03 wt. %, more preferably 0.05 wt. %, more preferably 0.07 wt. %, more preferably 0.1 wt. %, more preferably 0.13 wt. %, most preferably 0.15 wt. %.

Likewise, preferably, the weight ratio of asphaltenes to resins in the crude oil is relatively low. Said weight ratio may be of from 0.001 to 1, preferably 0.001 to 0.4, more preferably 0.005 to 0.2, most preferably 0.01 to 0.1.

Within the present specification, the term “naphthenic acids” means compounds which contain one or more carboxylic acid groups. For example, naphthenic acids may comprise fatty acids. The amount of naphthenic acids in the crude oil is generally relatively low and may be of from 1,000 to 2,000 parts per million by weight (ppmw), suitably 2,000 to 4,000 ppmw, based on total crude oil composition.

Within the present specification, the term “basic nitrogen compounds” means compounds which contain one or more basic nitrogen atoms. The amount of basic nitrogen compounds in the crude oil is generally relatively low and may be of from 10 to 1,000 parts per million by weight (ppmw), suitably 30 to 300 ppmw, based on total crude oil composition.

Naphthenic acids and basic nitrogen compounds can be measured using conventional analytical techniques, such as potentiometric titrations, infrared spectroscopy and mass spectrometry.

Within the present specification, the term “paraffin wax” means compounds which are solid at room temperature and which comprise a mixture of saturated, preferably highly linear (for example >90%) paraffins of which the weight average carbon number is of from 20 to 40.

Preferably, the crude oil has a paraffin wax content which is at least 1 wt. %, more preferably at least 2 wt. %, even more preferably at least 3 wt. %, and which is at most 50 wt. %, preferably at most 45 wt. %. That is to say, said paraffin wax content may for example be of from 1 to 50 wt. % or of from 2 to 45 wt. %.

Further, the crude oil that may be treated in the method of the present invention, may have an API ranging from less than 20 to higher than 40. Suitably, said API ranges of from 20 to 50, more suitably 25 to 45, most suitably 30 to 40.

In the method of the present invention, the temperature may be 60° C. or higher. By said temperature reference is made to the temperature in the hydrocarbon containing formation. Preferably, said temperature is of from 60 to 200° C., more preferably of from 60 to 150° C. In practice, said temperature may vary strongly between different hydrocarbon containing formations. In the present invention, said temperature may be at least 60° C., suitably at least 80° C., more suitably at least 90° C., most suitably at least 100° C. Further, said temperature may be at most 200° C., suitably at most 180° C., more suitably at most 160° C., most suitably at most 150° C.

In the present method of treating a hydrocarbon containing formation, in particular a crude oil-bearing formation, the surfactant(s) (an alkoxylated alcohol anionic surfactant (AAS) and optionally a second surfactant, such as an internal olefin sulfonate (IOS)) is or are applied in cEOR (chemical Enhanced Oil Recovery) at the location of the hydrocarbon containing formation, more in particular by providing the above-described composition to at least a portion of the hydrocarbon containing formation and then allowing the surfactant(s) from said composition to interact with the hydrocarbons in the hydrocarbon containing formation.

Normally, surfactants for enhanced hydrocarbon recovery are transported to a hydrocarbon recovery location and stored at that location in the form of an aqueous solution containing for example 30 to 35 wt. % of the surfactant(s). At the hydrocarbon recovery location, such solution would then be further diluted to a 0.05-2 wt. % solution, before it is injected into a hydrocarbon containing formation. By such dilution, an aqueous fluid is formed which fluid can be injected into the hydrocarbon containing formation, that is to say an injectable fluid. The water or brine used in such further dilution may originate from the hydrocarbon containing formation (from which hydrocarbons are to be recovered) or from any other source.

The total amount of the surfactant(s) in said injectable fluid may be of from 0.05 to 2 wt. %, preferably 0.1 to 1.5 wt. %, more preferably 0.1 to 1.0 wt. %, most preferably 0.2 to 0.5 wt. %.

Hydrocarbons may be produced from hydrocarbon containing formations through wells penetrating such formations. “Hydrocarbons” are generally defined as molecules formed primarily of carbon and hydrogen atoms such as oil and natural gas. Hydrocarbons may also include other elements, such as halogens, metallic elements, nitrogen, oxygen and/or sulfur. Hydrocarbons derived from a hydrocarbon containing formation may include kerogen, bitumen, pyrobitumen, asphaltenes, oils or combinations thereof. Hydrocarbons may be located within or adjacent to mineral matrices within the earth. Matrices may include sedimentary rock, sands, silicilytes, carbonates, diatomites and other porous media.

A “hydrocarbon containing formation” may include one or more hydrocarbon containing layers, one or more non-hydrocarbon containing layers, an overburden and/or an underburden. An overburden and/or an underburden includes one or more different types of impermeable materials. For example, overburden/underburden may include rock, shale, mudstone, or wet/tight carbonate (that is to say an impermeable carbonate without hydrocarbons). For example, an underburden may contain shale or mudstone. In some cases, the overburden/underburden may be somewhat permeable. For example, an underburden may be composed of a permeable mineral such as sandstone or limestone.

Properties of a hydrocarbon containing formation may affect how hydrocarbons flow through an underburden/overburden to one or more production wells. Properties include porosity, permeability, pore size distribution, surface area, salinity or temperature of formation. Overburden/underburden properties in combination with hydrocarbon properties, capillary pressure (static) characteristics and relative permeability (flow) characteristics may affect mobilisation of hydrocarbons through the hydrocarbon containing formation.

Fluids (for example gas, water, hydrocarbons or combinations thereof) of different densities may exist in a hydrocarbon containing formation. A mixture of fluids in the hydrocarbon containing formation may form layers between an underburden and an overburden according to fluid density. Gas may form a top layer, hydrocarbons may form a middle layer and water may form a bottom layer in the hydrocarbon containing formation. The fluids may be present in the hydrocarbon containing formation in various amounts. Interactions between the fluids in the formation may create interfaces or boundaries between the fluids. Interfaces or boundaries between the fluids and the formation may be created through interactions between the fluids and the formation. Typically, gases do not form boundaries with other fluids in a hydrocarbon containing formation. A first boundary may form between a water layer and underburden. A second boundary may form between a water layer and a hydrocarbon layer. A third boundary may form between hydrocarbons of different densities in a hydrocarbon containing formation.

Production of fluids may perturb the interaction between fluids and between fluids and the overburden/underburden. As fluids are removed from the hydrocarbon containing formation, the different fluid layers may mix and form mixed fluid layers. The mixed fluids may have different interactions at the fluid boundaries. Depending on the interactions at the boundaries of the mixed fluids, production of hydrocarbons may become difficult.

Quantification of energy required for interactions (for example mixing) between fluids within a formation at an interface may be difficult to measure. Quantification of energy levels at an interface between fluids may be determined by generally known techniques (for example spinning drop tensiometer). Interaction energy requirements at an interface may be referred to as interfacial tension. “Interfacial tension” as used herein, refers to a surface free energy that exists between two or more fluids that exhibit a boundary. A high interfacial tension value (for example greater than 10 dynes/cm) may indicate the inability of one fluid to mix with a second fluid to form a fluid emulsion. As used herein, an “emulsion” refers to a dispersion of one immiscible fluid into a second fluid by addition of a compound that reduces the interfacial tension between the fluids to achieve stability. The inability of the fluids to mix may be due to high surface interaction energy between the two fluids. Low interfacial tension values (for example less than 1 dyne/cm) may indicate less surface interaction between the two immiscible fluids. Less surface interaction energy between two immiscible fluids may result in the mixing of the two fluids to form an emulsion. Fluids with low interfacial tension values may be mobilised to a well bore due to reduced capillary forces and subsequently produced from a hydrocarbon containing formation. Thus, in surfactant cEOR, the mobilisation of residual oil is achieved through surfactants which generate a sufficiently low crude oil/water interfacial tension (IFT) to give a capillary number large enough to overcome capillary forces and allow the oil to flow.

Mobilisation of residual hydrocarbons retained in a hydrocarbon containing formation may be difficult due to viscosity of the hydrocarbons and capillary effects of fluids in pores of the hydrocarbon containing formation. As used herein “capillary forces” refers to attractive forces between fluids and at least a portion of the hydrocarbon containing formation. Capillary forces may be overcome by increasing the pressures within a hydrocarbon containing formation. Capillary forces may also be overcome by reducing the interfacial tension between fluids in a hydrocarbon containing formation. The ability to reduce the capillary forces in a hydrocarbon containing formation may depend on a number of factors, including the temperature of the hydrocarbon containing formation, the salinity of water in the hydrocarbon containing formation, and the composition of the hydrocarbons in the hydrocarbon containing formation.

As production rates decrease, additional methods may be employed to make a hydrocarbon containing formation more economically viable. Methods may include adding sources of water (for example brine, steam), gases, polymers or any combinations thereof to the hydrocarbon containing formation to increase mobilisation of hydrocarbons.

In the present invention, the hydrocarbon containing formation is thus treated with the diluted or not-diluted surfactant(s) containing solution, as described above. Interaction of said solution with the hydrocarbons may reduce the interfacial tension of the hydrocarbons with one or more fluids in the hydrocarbon containing formation. The interfacial tension between the hydrocarbons and an overburden/underburden of a hydrocarbon containing formation may be reduced. Reduction of the interfacial tension may allow at least a portion of the hydrocarbons to mobilise through the hydrocarbon containing formation.

The ability of the surfactant(s) containing solution to reduce the interfacial tension of a mixture of hydrocarbons and fluids may be evaluated using known techniques. The interfacial tension value for a mixture of hydrocarbons and water may be determined using a spinning drop tensiometer. An amount of the surfactant(s) containing solution may be added to the hydrocarbon/water mixture and the interfacial tension value for the resulting fluid may be determined.

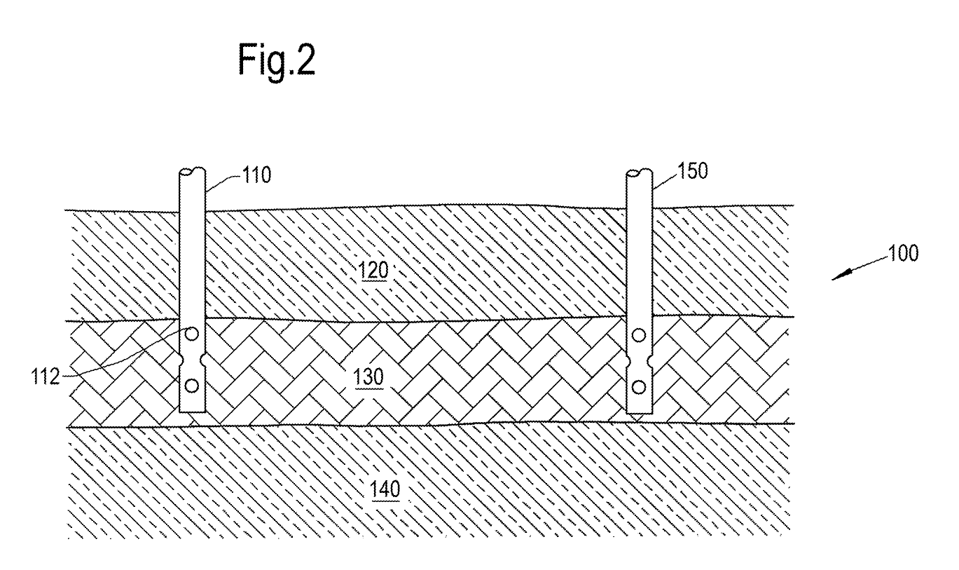

The surfactant(s) containing solution, diluted or not diluted, may be provided (for example injected in the form of a diluted aqueous fluid) into hydrocarbon containing formation 100 through injection well 110 as depicted in FIG. 2. Hydrocarbon containing formation 100 may include overburden 120, hydrocarbon layer 130 (the actual hydrocarbon containing formation), and underburden 140. Injection well 110 may include openings 112 (in a steel casing) that allow fluids to flow through hydrocarbon containing formation 100 at various depth levels. Low salinity water may be present in hydrocarbon containing formation 100.

The surfactant(s) from the surfactant(s) containing solution may interact with at least a portion of the hydrocarbons in hydrocarbon layer 130. This interaction may reduce at least a portion of the interfacial tension between one or more fluids (for example water, hydrocarbons) in the formation and the underburden 140, one or more fluids in the formation and the overburden 120 or combinations thereof.

The surfactant(s) from the surfactant(s) containing solution may interact with at least a portion of hydrocarbons and at least a portion of one or more other fluids in the formation to reduce at least a portion of the interfacial tension between the hydrocarbons and one or more fluids. Reduction of the interfacial tension may allow at least a portion of the hydrocarbons to form an emulsion with at least a portion of one or more fluids in the formation. The interfacial tension value between the hydrocarbons and one or more other fluids may be improved by the surfactant(s) containing solution to a value of less than 0.1 dyne/cm or less than 0.05 dyne/cm or less than 0.001 dyne/cm.

At least a portion of the surfactant(s) containing solution/hydrocarbon/fluids mixture may be mobilised to production well 150. Products obtained from the production well 150 may include components of the surfactant(s) containing solution, methane, carbon dioxide, hydrogen sulfide, water, hydrocarbons, ammonia, asphaltenes or combinations thereof. Hydrocarbon production from hydrocarbon containing formation 100 may be increased by greater than 50% after the surfactant(s) containing solution has been added to a hydrocarbon containing formation.

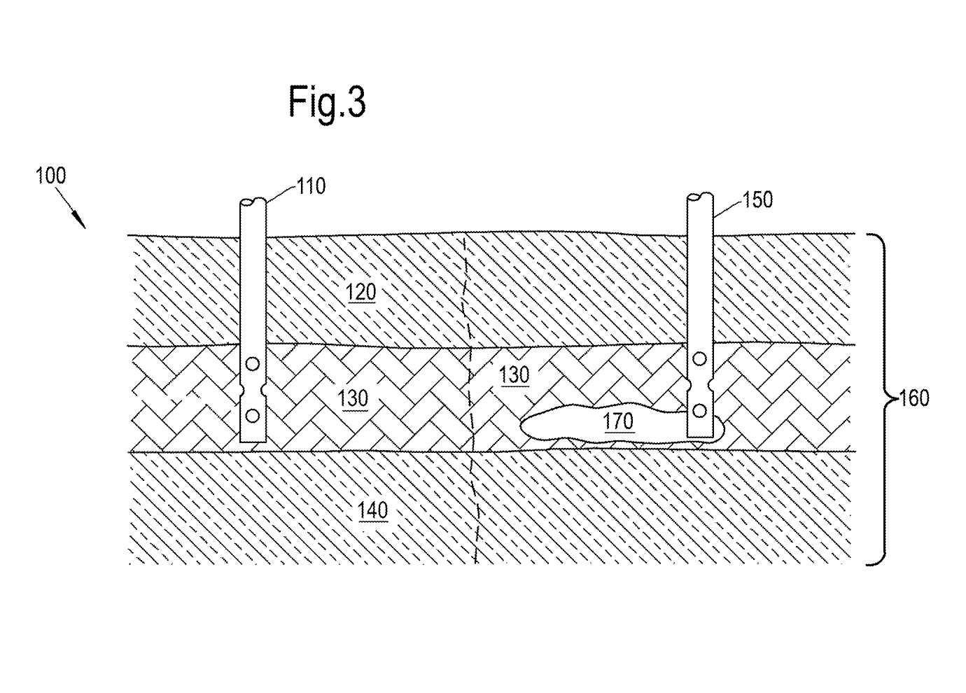

The surfactant(s) containing solution, diluted or not diluted, may also be injected into hydrocarbon containing formation 100 through injection well 110 as depicted in FIG. 3. Interaction of the surfactant(s) from the surfactant(s) containing solution with hydrocarbons in the formation may reduce at least a portion of the interfacial tension between the hydrocarbons and underburden 140. Reduction of at least a portion of the interfacial tension may mobilise at least a portion of hydrocarbons to a selected section 160 in hydrocarbon containing formation 100 to form hydrocarbon pool 170. At least a portion of the hydrocarbons may be produced from hydrocarbon pool 170 in the selected section of hydrocarbon containing formation 100.

It may be beneficial under certain circumstances that an aqueous fluid, wherein the surfactant(s) containing solution is diluted, contains inorganic salt, such as sodium chloride, sodium hydroxide, potassium chloride, ammonium chloride, sodium sulfate or sodium carbonate. Such inorganic salt may be added separately from the surfactant(s) containing solution or it may be included in the surfactant(s) containing solution before it is diluted in water. The addition of the inorganic salt may help the fluid disperse throughout a hydrocarbon/water mixture and to reduce surfactant loss by adsorption onto rock. This enhanced dispersion may decrease the interactions between the hydrocarbon and water interface. The decreased interaction may lower the interfacial tension of the mixture and provide a fluid that is more mobile.

The invention is further illustrated by the following Examples.

### Examples

### 1. Chemicals Used in the Examples

1.1 Alcohol Propoxy Sulfate Surfactants A, B and C Surfactants A to C were Anionic Surfactants of the Following Formula (V):

[R—O—[R′—O]ₓ—SO₃⁻][Na⁺] Formula (V)

The R—O moiety in the surfactants of above formula (V) originated from a blend of primary alcohols of formula R—OH, wherein R was an aliphatic group. The aliphatic group R was randomly branched and had a branching index of 1.3. The branches consisted of 87% of methyl branches and 13% of ethyl branches. The R′—O moiety in the surfactants of above formula (V) originated from propylene oxide. In Table 1 below, the weight average carbon number for the aliphatic group R is shown, as well as “x” which represents the average number of moles of propylene oxide (PO) groups per mole of alcohol.

TABLE 1

| | Weight average | Average number of |
|---|---|---|
| Surfactant | carbon number | PO groups (x) |
| A | 16.7 | 7 |
| B | 12.6 | 9 |
| C | 12.6 | 7 |

1.2 IOS Surfactant D

Internal olefin sulfonate (IOS) surfactant D was an IOS surfactant which originated from a mixture of C15-18 internal olefins which was a mixture of even and odd carbon number olefins and had a weight average carbon number of 16.5. 1.0% of the total internal olefins were C14 internal olefins, 23.7% were C15, 27.2% were C16, 26.8% were C17, 18.7% were C18, and 2.7% were C19. Surfactant D was a sodium salt. Further properties for said surfactant are mentioned in Table 2 below.

TABLE 2

| | Surfactant D |
|---|---|
| Properties of olefins used in IOS | |
| preparation | |
| Weight average carbon number | 16.5 |
| Weight ratio branched: linear ⁽¹⁾ | 0.09:1 |
| Composition of IOS | |
| Hydroxyalkane sulfonates (%) | 81 |
| Alkene sulfonates (%) | 18 |
| Di-sulfonates (%) | 0.5 |
| Components other than IOS | |
| Free oil (wt. %) ⁽²⁾ | 3.1 |
| NEODOL ™ 91-8 (non-ionic surfactant) ⁽²⁾ | 5.0 |
| Na₂SO₄ (wt. %) ⁽²⁾ | 3.1 |

⁽¹⁾ Determined by GC.
⁽²⁾ Relative to IOS.

NEODOL™ 91-8 as mentioned in Table 2 above is a mixture of ethoxylates of C₉, C₁₀ and C₁₁ alcohols wherein the average value for the number of the ethylene oxide groups is 8.

The IOS surfactant D containing aqueous solution had an active matter content of approximately 30 wt. % (before mixing with the AAS surfactant A, B or C). “Active matter” herein means all matter excluding water from said aqueous solution.

1.3 Co-Solvent

In cases where a co-solvent was used, it was 2-methyl-1-propanol (iso-butyl alcohol, hereinafter abbreviated as “IBA”).

### 2. Crude Oils Used in the Examples

Two crude oils were used in the Examples, designated as A and B. Crude oils A and B were from different oil reservoirs from different regions of the world. Oil properties and oil components for said crude oils are shown in Table 3 below.

TABLE 3

| | | |
|---|---|---|
| Crude oil | A | B |
| Reservoir temperature, ° C. | 62 | 29 |
| Cloud point (cold finger | 45-47 | 26-29 |
| method), ° C. | | |
| API gravity | 26.0 | 36.5 |
| Dynamic viscosity, Cp at 10⁻¹ | 30.9 | 3.0 |
| (at reservoir temperature) | | |
| Density, g/cm³ (at reservoir | 0.85 | 0.85 |
| temperature) | | |
| TAN, mg KOH/g oil | 0.5 | 0.1 |
| a: resins, wt. % | 11.5 | 8.7 |
| b: asphaltenes, wt. % | 0.1 | 0.5 |
| Weight ratio b/a | 0.01 | 0.06 |
| x: saturates, wt. % | 63.3 | 51.6 |
| y: aromatics, wt. % | 25.1 | 39.1 |
| Weight ratio x/y | 2.5 | 1.3 |
| Paraffin wax, wt. % ⁽¹⁾ | 42.2 | 4.0 |
| Napthenic acids, ppmw | 140 | <50 |
| Basic nitrogen compounds, | 1090 | 316 |
| ppmw | | |

⁽¹⁾ The paraffin wax content was determined in accordance with “UOP Method 46-85” for determining “Paraffin Wax Content of Petroleum Oils and Asphalts” from 1964 (re-issued in 1985) .

### 3. Evaluation Tests

Evaluated properties of surfactant compositions were microemulsion phase behaviour and aqueous solubility. The tests used to assess these properties are described hereinbelow.

3.1 Microemulsion Phase Behaviour

In order to determine microemulsion phase behaviour, aqueous solutions comprising (i) IOS surfactant D and (ii) one of AAS surfactants A to C and having different salinities were prepared. In tubes, the aqueous solutions were mixed with crude oil A or B in a volume ratio of 1:1 and the system was allowed to equilibrate for days or weeks at 62° C. (Crude oil A) or 29° C. (Crude oil B).

Microemulsion phase behaviour tests were carried out to screen AAS surfactants A to C for their potential to mobilize residual oil by means of lowering the interfacial tension (IFT) between the oil and water. Microemulsion phase behaviour was first described by Winsor in “Solvent properties of amphiphilic compounds”, Butterworths, London, 1954. The following categories of emulsions were distinguished by Winsor: “type I” (oil-in-water emulsion), “type II” (water-in-oil emulsion) and “type III” (emulsions comprising a bicontinuous oil/water phase). A Winsor Type III emulsion is also known as an emulsion which comprises a so-called “middle phase” microemulsion. A microemulsion is characterised by having the lowest IFT between the oil and water for a given oil/water mixture.

For anionic surfactants, increasing the salinity (salt concentration) of an aqueous solution comprising the surfactant(s) causes a transition from a Winsor type I emulsion to a type III and then to a type II. Optimal salinity is defined as the salinity where equal amounts of oil and water are solubilised in the middle phase (type III) microemulsion. The oil solubilisation ratio is the ratio of oil volume (Vₒ) to neat surfactant volume (Vₛ) and the water solubilisation ratio is the ratio of water volume (V_{w}) to neat surfactant volume (Vₛ). The intersection of Vₒ/Vₛ and V_{w}/Vₛ as salinity is varied, defines (a) the optimal salinity and (b) the solubilisation parameter (hereinafter referred to as “SP”) at the optimal salinity. It has been established by Huh that IFT is inversely proportional to the square of the solubilisation parameter (Huh, “Interfacial tensions and solubilizing ability of a microemulsion phase that coexists with oil and brine”, J. Colloid and Interface Sci., September 1979, p. 408-426). A high solubilisation parameter, and consequently a low IFT, is advantageous for mobilising residual oil via surfactant EOR. That is to say, the higher the solubilisation parameter the more “active” the surfactant.

The detailed microemulsion phase test method used in these Examples has been described previously, by Barnes et al. under Section 2.1 “Glass pressure tube test” in “Development of Surfactants for Chemical Flooding at Difficult Reservoir Conditions”, SPE 113313, 2008, p. 1-18. In summary, this test provides three important data:

(a) the optimal salinity, expressed as wt. % NaCl;

(b) the solubilisation parameter (SP; in ml/ml; assumption: density surfactant=1 g/ml) at the optimal salinity (this usually takes several days or weeks to allow the phases to settle at equilibrium), wherein the interfacial tension (IFT, in mN/m) is calculated from the solubilisation parameter using the “Huh” equation IFT=0.3/SP² as referred to above.

(c) in addition, a measure of the “activity” of the microemulsion is obtained by the “sway test method” described below.

The original methodology for judging the quality of the emulsion in the microemulsion phase test when gently mixing oil and water by swaying tubes is described by Nelson et al. in “Cosurfactant-Enhanced Alkali Flooding”, SPE/DOE 12672, 1984, p. 413-421 (see Table 1). This methodology has been further developed by Shell as the “sway test method” where the emulsion is visually judged in terms of four criteria:

(1) its homogeneity: the more homogeneous and “creamier”, the better as this indicates a more effective oil emulsification;

(2) its mobility: the more mobile (lower viscosity), the better;

(3) its colour: the lighter the colour, the better, indicative of microemulsions around the optimal salinity; and

(4) its glass wetting: a homogeneous film adhering to the glass surface is judged as good.

A rating method has been developed and a number ranging from 1 to 5 is given to overall microemulsion activity, from 5 for very high to 1 for very low or no activity.

3.2 Aqueous Solubility

Aqueous solubility may be evaluated via light transmittance measurements and/or visual observation of aqueous, surfactant containing solutions, as further described hereinbelow.

### 4. Examples

In Tables 4, 5 and 6 below, the conditions and results of the above-described evaluation tests are summarized for Examples 1, 1a, 1b and 2 and for Comparison Examples 1-2.

In Examples 1, 1a, 1b and 2, Surfactant A (in accordance with the invention) was used as the AAS surfactant, whereas in Comparison Examples 1-2, Comparison Surfactants B and C (not in accordance with the invention), respectively, were used as the AAS surfactant.

In Examples 1, 1a and 1b and Comparison Example 1, the salinity of the aqueous solution was varied by varying the Na₂CO₃ concentration, IOS surfactant D was used as additional surfactant and no co-solvent was used. In Example 2 and Comparison Example 2, said salinity was varied by varying the TDS concentration (“TDS” refers to “total dissolved solids”), IOS surfactant D was used as additional surfactant and a co-solvent (IBA) was used.

As described above, in section 3.1 (“Microemulsion phase behaviour”), the volume ratio of oil to water (that is to say, the aqueous, surfactant containing solution) was 1:1 (50:50), with the exception of Examples 1a and 1b where said oil to water ratio was 30:70 (Example 1a) and 20:80 (Example 1b).

TABLE 4

| | Example ⁽¹⁾ | |
|---|---|---|
| | E1 | C1 |
| AAS surfactant | A | B |
| IOS surfactant | D | D |
| Weight ratio AAS:IOS | 2:1 | 2:1 |
| Total surfactant, wt. % | 0.3 | 0.3 |
| Co-solvent, wt. % | none | none |
| Crude oil | A | A |
| Oil:water volume ratio | 50:50 | 50:50 |
| Temperature, ° C. | 62 | 62 |
| Na₂CO₃, wt. % ⁽²⁾ | | |
| 0.00 | II− | II− |
| 0.40 | II− | II− |
| 1.00 | III | II− |
| 1.40 | III | II− |
| 2.00 | III | II− |
| 2.40 | II+ | II− |
| 3.00 | II+ | III |
| 3.40 | II+ | II+ |
| 3.50 | II+ | n.m. |
| 4.00 | II+ | II+ |
| Na₂CO₃ concentration | 1.00 to 2.00 | 3.00 |
| range for Winsor type | | |
| III microemulsion | | |
| Aqueous solubility ⁽³⁾ | Clear at 62° C. | Clear at 62° C. |
| | until 5.0% Na₂CO₃ | until 5.0% Na₂CO₃ |

n.m.=not measured

(1) “E”=Example; “C”=Comparison Example. In this table, weight percentages are based on total weight of the aqueous solution (only).

(2) Phase behaviour was tested at various Na₂CO₃ concentrations (salinities) at the stated temperature. “II−”, “III” and “II+” refer to emulsion (Winsor) types “I”, “III” and “II”, respectively, as described above.

(3) An increasing wt. % of Na₂CO₃ was added to the AAS and IOS surfactants containing solution at the reservoir temperature to determine the Na₂CO₃ concentration at which a transition for the resulting solution from clear to slightly hazy occurs.

TABLE 5

| | Example ⁽¹⁾ | |
|---|---|---|
| | E1a | E1b |
| AAS surfactant | A | B |
| IOS surfactant | D | D |
| Weight ratio AAS:IOS | 2:1 | 2:1 |
| Total surfactant, wt. % | 0.3 | 0.3 |
| Co-solvent, wt. % | none | none |
| Crude oil | A | A |
| Oil:water volume ratio | 30:70 | 20:80 |
| Temperature, ° C. | 62 | 62 |
| Na₂CO₃, wt.% ⁽²⁾ | | |
| 0.00 | II− | II− |
| 0.40 | II− | II− |
| 1.00 | III | III |
| 1.40 | III | III |
| 2.00 | III | III |
| 2.40 | III | III |
| 3.00 | II+ | II+ |
| 3.40 | II+ | II+ |
| 3.50 | II+ | II+ |
| 4.00 | II+ | II+ |
| Na₂CO₃ concentration | 1.00 to 2.40 | 1.00 to 2.40 |
| range for Winsor type | | |
| III microemulsion | | |
| Aqueous solubility | Clear at 62° C. | Clear at 62° C. |
| | until 5.0% Na₂CO₃ | until 5.0% Na₂CO₃ |

See notes under Table 4.

TABLE 6

| | Example (1) | |
|---|---|---|
| | E2 | C2 |
| AAS surfactant | A | C |
| IOS surfactant | D | D |
| Weight ratio AAS:IOS | 3:1 | 3:1 |
| Total surfactant, wt. % | 1.0 | 1.0 |
| Co-solvent, wt. % | 0.5 | 0.5 |
| Crude oil | B | B |
| Oil:water volume ratio | 50:50 | 50:50 |
| Temperature, ° C. | 29 | 29 |
| TDS (×1000 ppmw) ⁽²⁾ | | |
| 2.00 | II− | II− |
| 2.50 | II− | II− |
| 3.00 | II− | II− |
| 3.50 | II− | II− |
| 4.00 | III (2) | II− |
| 4.50 | III (4) | II− |
| 4.88 | III (3) | II− |
| 5.50 | II+ | n.m. |
| TDS concentration range | 4.00 to 4.88 | no activity |
| for Winsor type III | | |
| microemulsion | | |
| Average activity in type | 3 | no activity |
| III region ⁽²⁾ | | |
| Optimal salinity ⁽³⁾, wt. % | 4.8 +/− 0.3 | n.m. |
| NaCl | | |
| SP ⁽³⁾, ml/ml | 12 +/− 5 | n.m. |
| Aqueous solubility ⁽⁴⁾ | Clear at 29° C. | Clear at 29° C. |
| | at 5.5 TDS | at 5.5 TDS |
| | (×1000 ppmw) | (×1000 ppmw) |

n.m. = not measured
⁽¹⁾ “E” = Example; “C” = Comparison Example. In this table, weight percentages are based on total weight of the aqueous solution (only).
⁽²⁾ Phase behaviour was tested at various TDS concentrations (salinities) at the stated temperature. “II−”, “III” and “II+” refer to emulsion (Winsor) types “I”, “III” and “II”, respectively, as described above. “TDS” refers to “total dissolved solids” which comprise dissolved salts comprising salts comprising divalent cations, such as magnesium chloride and calcium chloride, and salts comprising monovalent cations, such as sodium chloride, potassium chloride and sodium carbonate. For those TDS concentrations where type III region was observed, the number shown between parentheses is the (sway test) activity number, for which latter number an average value is also shown.
(3) These parameters (optimal salinity and SP) were measured in static phase tests.
(4) The amount of TDS (×1000 ppmw) in the AAS and IOS surfactants and co-solvent containing solution was increased from 2.0 to 5.5 at the reservoir temperature, and the clarity of the resulting solution was then assessed.

From Tables 4, 5 and 6, it appears that in those cases where an AAS surfactant having a weight average carbon number (for the nonalkoxylated alcohol precursor) of from 13 to 30 (here: AAS surfactant A) is used, surprisingly and advantageously, for a relatively wide range of salinities a Winsor type III microemulsion was observed, as compared to AAS surfactants having a weight average carbon number lower than 13 (here: AAS surfactants B and C), in relation to crude oils having a relatively high saturates to aromatics ratio.

According to Table 4, said range of salinities at least covered the range of from 1.00 to 2.00 wt. % of Na₂CO₃ for Example 1 (using AAS surfactant A) whereas in Comparative Example 1 (using AAS surfactant B) a Winsor type III microemulsion was only reached once, namely at 3.00 wt. % of Na₂CO₃.

The above finding is even more surprising since the additional 2 propylene oxide (PO) groups for surfactant B used in Comparative Example 1 (see Table 1 above) might have been expected to improve the surfactant's hydrophobicity and thereby result in a better match between the surfactant and the crude oil tested (crude oil A).

Still further, from Table 5, it appears that in Examples 1a and 1b also at other oil:water volume ratios (other than in Example 1), a good microemulsion phase behaviour is seen. For, according to Table 5, the range of salinities within which a Winsor type III microemulsion was observed at least covered the range of from 1.00 to 2.40 wt. % of Na₂CO₃ (using AAS surfactant A). Showing such good microemulsion phase behaviour in a wide range of oil:water volume ratios is an important selection criterion in relation to crude oils having a TAN (“Total Acid Number”).

Therefore, it can be concluded that in relation to crude oils having a relatively high saturates to aromatics ratio, AAS surfactants having a weight average carbon number (for the nonalkoxylated alcohol precursor) of from 13 to 30 (Examples 1, 1a and 1b: AAS surfactant A) are surprisingly better matched to such oils than AAS surfactants having a weight average carbon number lower than 13 (Comparative Example 1: AAS surfactant B).

The foregoing is also supported in relation to the other crude oil tested (crude oil B). According to Table 6, the range of salinities within which a Winsor type III microemulsion was observed at least covered the range of from 4.00 to 4.88 (×1,000 ppmw) of TDS for Example 2 (using AAS surfactant A) whereas in Comparative Example 2 (using AAS surfactant C) a Winsor type III microemulsion was not observed at all. For said AAS surfactants A and C, the average number of PO groups was the same (see Table 1 above). They only differed in terms of the weight average carbon number (for the nonalkoxylated alcohol precursor).

Further, it appeared (see Table 6), that the overall microemulsion activity, as determined by the above-described “sway test method”, in the above-mentioned range of salinities within which a Winsor type III microemulsion was observed, was relatively high for Example 2 for which the average overall microemulsion activity in that range was 3.

### 5. Core Flood Test

Further, a core flood test was carried out on crude oil A using a combination of AAS surfactant A and IOS surfactant D in a weight ratio of AAS:IOS of 2:1 (just like in Example 1). The core flood test was performed in a Bentheimer sandstone core, positioned vertically in an oven, at a temperature of 62° C. Properties of said core sample are given in Table 7 below.

TABLE 7

| Material | Bentheimer sandstone |
|---|---|
| Porosity, % | 21.0 ± 0.1 |
| Permeability to brine, Darcy | 2.4 ± 0.1 |
| Diameter, cm | 3.7 ± 0.1 |
| Length, cm | 17.0 ± 0.1 |
| Pore volume, cm³ | 38.4 ± 0.5 |

The core was flushed with CO₂ for 30 minutes. Subsequently, it was saturated with a synthetic hard brine for 20 pore volumes (PV). The composition of the synthetic hard brine is given in Table 8 below.

TABLE 8

| Concentration of salt (ppmw) | |
|---|---|
| NaCl | 6,308 |
| MgCl₂•6H₂O | 338 |
| CaCl₂ | 630 |
| KCl | 176 |
| TDS | 7,400 |

Crude oil A, which before this core flood test was diluted with 12.5 wt. % of cyclohexane, was then injected at 1.0 cm³/min under gravity stable conditions for 3.0 PV. Water flooding was then performed using said synthetic hard brine. at 0.25 cm³/min for 6.0 PV. Then a slug of 0.30 PV of a so-called “ASP” (alkali-surfactant-polymer) solution, the composition of which is given in Table 9 below, was injected at 0.25 cm³/min. The viscosity of the ASP solution was 38.6 mPa·s at 10 s⁻¹ and 62° C.

Table 9

| Components ASP solution | Amount |
|---|---|
| AAS surfactant A | 0.2 wt. % |
| IOS surfactant D | 0.1 wt. % |
| Na₂CO₃ | 1.5 wt. % |
| Hydrolysed polyacrylamide (HPAM) polymer | 2600 ppmw |
| (Flopaam 3630S) | |
| Synthetic softened brine (composition in Table | Remainder |
| 10 below) | |

TABLE 10

| Concentration of salt (ppmw) | |
|---|---|
| NaCl | 4,416 |
| NaHCO₃ | 348 |
| Na₂SO₄ | 661 |
| TDS | 5,425 |

Then a polymer solution was injected at 0.25 cm³/min for 2.0 PV. The polymer solution was made using synthetic softened brine (the composition of which is given in Table 10) and 1850 ppmw of a polymer (Flopaam 3630S). The viscosity of the polymer solution was 38.7 mPa·s at 10 s⁻¹ and 62° C.

In Table 11 below, the saturations with water and oil in the core during the different subsequent phases of this test are given.

TABLE 11

| Saturation (vol. %) | Water | Oil |
|---|---|---|
| Before oil injection | 100.0 | 0.0 |
| After oil injection | 14.9 | 85.1 |
| After waterflood | 63.1 | 36.9 |
| After ASP/polymer injections ⁽*⁾ | 97.5 | 2.5 |

⁽*⁾ Oil recovery = [(36.9-2.5)/36.9]*100% = 93%

From Table 11 it can be concluded that the oil recovery caused by the ASP and polymer injections as such, in which injections a surfactant (“S”) containing composition in accordance with the present invention was injected, was 93% which is a substantially high oil recovery.

We claim:

1. A method of treating a hydrocarbon containing formation, comprising the following steps:
a) providing a composition, which comprises a surfactant which is a compound of the formula (I)
R—O—[R′—O]ₓ—X Formula (I)
wherein R is a hydrocarbyl group having a weight average carbon number of from 13 to 30, R′—O is an alkylene oxide group, x is the number of alkylene oxide groups R′—O, and X is selected from the group consisting of: (i) a group comprising a sulfate moiety; (ii) a group comprising a carboxylate moiety; and (iii) a group comprising a sulfonate moiety, to at least a portion of the hydrocarbon containing formation, wherein the hydrocarbon containing formation comprises a crude oil which has a weight ratio of saturates to aromatics of from 0.6 to 5.0; and
b) allowing the surfactant from the composition to interact with the hydrocarbons in the hydrocarbon containing formation.

2. Process according to claim 1, wherein X is a group comprising a sulfate moiety.
